(19) United States
(12) Patent Application Publication
(10) Pub. No.: US 2009/0046748 A1
(43) Pub. Date: Feb. 19, 2009

(54) Light-emitting device with precisely tuned and narrowed spectral width of optical output and an optical signal source providing the same

(75) Inventor: Takashi Kato, Yokohama-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: SUMITOMO ELECTRIC INDUSTRIES, LTD.

(21) Appl. No.: 12/222,441

(22) Filed: Aug. 8, 2008

(30) Foreign Application Priority Data
Aug. 14, 2007 (JP) 2007-211445
Aug. 15, 2007 (JP) 2007-211907

(51) Int. Cl. H01S 3/10

(52) U.S. Cl. 372/20

(57) ABSTRACT

A light-emitting device whose output wavelength is easily variable is disclosed. The device provides a light-generating portion that emits light by the carrier injection and a variable wavelength filter that sets a specific wavelength λr. The variable wavelength filter includes two ring waveguide optical coupled with each other and having optical paths different from each other and at least an electrode to apply an electrical signal to the corresponding ring waveguide. By tuning the specific wavelength λr to the wavelength emitted from the light-generating portion, the output wavelength from the light-emitting device may be narrowed.

### BACKGROUND OF THE INVENTION

1. Field of the Invention

The present invention relates to a light-emitting device with a precisely tuned output wavelength and extremely narrowed spectral width of the optical output, and an optical signal source providing such a light-emitting device.

2. Related Prior Art

Conventionally, a light source in which a light emitting diode (LED) is a primary light-emitting device shows an output wavelength distributing in a wide range. Such a light source may be applicable only to a system with a slow transmission speed and a short distance because the wide range of the spectrum of the optical source inevitably accompanies with the large dispersion of the optical fiber.

While, another light source providing a laser diode as a primary light-emitting device also accompanies with a spread spectrum when the laser diode is directly modulated at a high speed, which is called as the chirp phenomenon, even when the laser diode is a type of the distributed feedback (DFB) laser or the distributed Bragg reflector (DBR) laser where the laser diode provides an optical grating therein. This spread spectrum also restricts the transmission speed and the transmission distance of the optical system using the optical fiber.

A United States Patent, published as US 20040008933A, has discloses an optical transmitter where an etalon filter narrows the spectral width of the light output from the laser diode. However, it is necessary to narrow the output spectrum effectively and adequately to arrange the position and the temperature of the etalon filter.

Further, the output wavelength of the laser diode is substantially determined by the physical parameter, the band gap wavelength, of the semiconductor material. It is necessary to control the temperature of the laser diode to change the band gap wavelength optionally. A United States Patent, US 20060222039A, has disclosed a light-emitting device in which a laser diode emits light with optional wavelength by providing a ring resonator within the laser cavity. However, when this device is directly modulated, its emission spectrum suffers from spreading because both the ring resonators and the gain region are formed in the laser cavity.

### SUMMARY OF THE INVENTION

A light-emitting device of the invention, which emit light with a variable wavelength, comprises a light-generating portion and a variable wavelength filter optically coupled with the light-generating portion. A feature of the light-emitting device of the present invention is that the variable wavelength filter includes the first ring waveguide with an electrode. This ring waveguide shows a plurality of transmission maxima, each maximum depending on an optical path length of the ring waveguide. In the present invention, one of the transmission maxima is tuned to a wavelength of the light generating in the light-generating portion by applying an electrical signal to the electrode.

Because the transmission maxima of the ring waveguide have a quite narrow bandwidth, the light emitted from the device shows a quite narrow spectral width and the center of the spectrum is easily varied only by applying the electrical signal to the electrode.

The present light-emitting device in the features thereof is unconcerned with a type of the light-generating portion. Various types of light-generating portion are applicable, such as the light-emitting diode (LED) to emit super luminescent light with a wide spectrum, the DFB laser diode whose emission spectrum may be widened by the direct modulation, and the DBR laser diode also showing a widened spectrum by the direct modulation.

When the light-generating portion provides the LED, the variable wavelength filter may provide second ring waveguide with the electrode. The vernier effect of these two ring waveguides may tune the emission wavelength and may narrow the spectral width of the light output from the device by adjusting the electrical signals applied to each ring waveguide.

When the light-generating portion provides the DFB laser diode or the DBR laser diode, the variable wavelength filter includes at least one ring waveguide whose one of transmission maxima may be tuned to the wavelength of the light output from the light-generating portion, which is the diffraction wavelength of the DFB laser diode or the DBR laser diode.

The light-emitting device may further provide a photodiode to detect light transmitted through the variable wavelength filter,.and the variable wavelength filter may be tuned based on the detected result by the photodiode. The light-emitting device may further provide a semiconductor optical amplifier to amplify the light transmitted through the variable wavelength filter. Further, the light-generating portion, the wavelength variable filter, the photodiode, and the semiconductor optical amplifier may be built on a semiconductor substrate.

### BRIEF DESCRIPTION OF DRAWINGS

FIG. 1 schematically illustrates a plane view of a light-emitting device according to the first embodiment of the invention;

FIG. 2 explains a vernier effect caused by two ring waveguide whose free spectral ranges are different from each other;

FIG. 3 illustrates a cross section of the light-generating portion taken along the line III-III shown in FIG. 1;

FIG. 4 illustrates a cross section of the ring waveguide taken along the line IV-IV shown in FIG. 1;

FIG. 5A schematically illustrates a spectrum of light generated in the light-generating portion shown in FIG. 1 and FIG. 5B schematically illustrates a spectrum of light emitted from the light-emitting device;

FIG. 6 schematically illustrates a plane view of a light-emitting device with a bent waveguide according to the second embodiment of the invention;

FIG. 7 schematically illustrates a plane view of a light-emitting device with the elements therein making a substantial angle with respect to the facet of the substrate;

FIG. 8 schematically illustrates a plane view of a light-emitting device according to the fourth embodiment of the invention, where the device provides a DFB laser diode in the light-generating portion;

FIG. 9 is a cross section of the light-generating portion of the device shown in FIG. 8, the cross section being taken along the line III-III shown in FIG. 8;

FIG. 10A schematically illustrates a spectrum of the light generating in the light-generating portion with the DFB structure, FIG. 10B explains the vernier effect caused by two ring waveguides in the variable wavelength filter; and FIG. 10C schematically illustrates a spectrum of the light output from the light-emitting device according to the fourth embodiment of the invention;

FIG. 11 schematically illustrates a plane view of a light-emitting device according to the fifth embodiment of the invention, where the device provides a DRB laser diode in the light-generating portion;

FIG. 12 schematically illustrates a cross section of the light-generating portion of the device shown in FIG. 11, where the cross section is taken along the line III-III shown in FIG. 11;

FIG. 13 is a plane view of a light-emitting device according to the sixth embodiment of the invention;

FIG. 14 is a plane view of a light-emitting device according to the seventh embodiment of the invention, where the device provides a photodiode to detect light transmitted through the variable wavelength filter;

FIG. 15 is a block diagram of a light source providing a light-emitting device of one of first to seventh embodiment of the invention;

FIG. 16 is a block diagram of another light source that provides a light-emitting device of one of first to seventh embodiment of the invention; and

FIG. 17 is a block diagram of still another light source that provides a light-emitting device of one of first to seventh embodiment of the invention.

### DESCRIPTION OF PREFERRED EMBODIMENTS

Next, preferred embodiments of the present invention will be described as referring to accompanying drawings. In the description of the drawings, the same elements will be referred by the same numerals or he same symbols without overlapping explanations. Further, the dimensions of the drawings do not always reflect the description thereof.

### First Embodiment

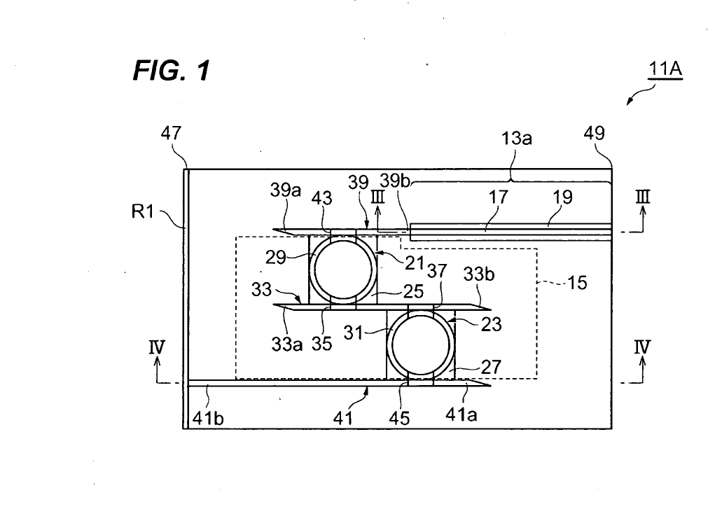

FIG. 1 schematically illustrates a semiconductor light-emitting device 11A according to the first embodiment of the invention. The device 11A is preferably applicable to the wavelength addressing system where the signal wavelengths are assigned to respective users located in short distances, typically less than a few hundred meters, or to the wavelength division multiplexing (WDM) system where the signal wavelengths are assigned to respective services. The device 11A provides a substrate, on which a light-generating portion 13a and a variable wavelength filter 15 optically coupled with the light-generating portion 13a.

In the present embodiment, the light-generating portion 13a is a type of the light emitting diode (LED) that emits super luminescent light with a wide spectrum. The light-generating portion 13a comprises a semiconductor active waveguide 17 including an active layer that generates light by injecting carriers therein and an electrode 19 to inject carriers into the active waveguide 17.

The wavelength variable filter 15 provides two ring resonators, 21 and 23, and two electrodes, 25 and 27, each provided with its corresponding ring resonator, 21 and 23. The wavelength variable filter 15 thus configured is often called as the multiple ring resonator. The ring resonators, 21 and 23, each includes a ring waveguide, 29 and 31, whose optical path lengths are different from the other. The ring waveguides, 29 and 31, are also one type of the semiconductor waveguide extending along a closed curve, typically a circle with a diameter from 10 to 500 micron meters. However, the shape of the ring waveguides, 29 and 31, is not restricted to the circle; any shape at least constituting a closed loop may be applicable.

The ring resonators, 21 and 23, show the transmission spectrum containing a plurality of the maximum. Specifically, the transmission spectrum of the ring resonators, 21 and 23, has a plurality of peaks whose interval coincides with the free spectral range (hereafter denoted as FSR) determined by the optical path length thereof. These two ring resonators, 21 and 23, are optically coupled with each other.

Another semiconductor waveguide 33 may optically couple one of the ring resonator, 21 or 23, with the other. That is, a portion in a side close to its end portion 33a optically couples with the one of the ring resonator 29, while another portion close to the other end portion 33b optically couples with the other ring resonator 31. The optical coupling between the waveguide 33 and the ring resonators, 29 and 31, are performed by the optical couplers, 35 and 37, which may be, for example, an optical directional coupler or a multimode interference (MMI) coupler.

The waveguide 33 provides the end portions, 33a and 33b, which are terminated so as to reduce the reflection at the end of the waveguide, for instance, the waveguide 33 gradually narrows its width toward the end, the waveguide bends its optical axis near the end, or the waveguide accompanies with a light-absorbing layer.

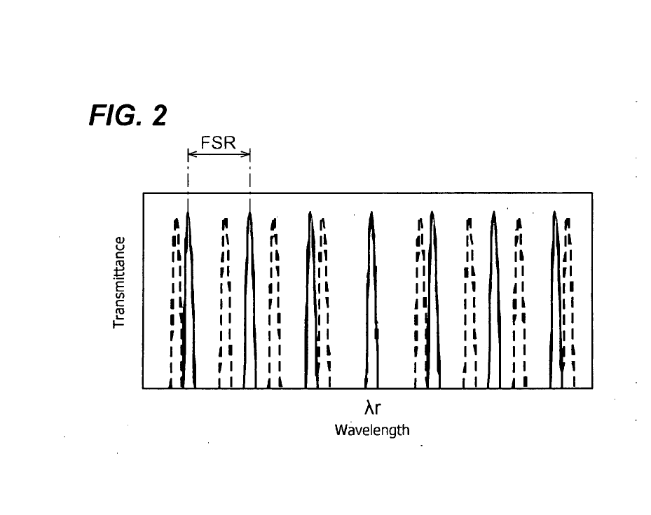

Next, a function of the variable wavelength filter 15 will be described as referring to FIG. 2. FIG. 2 shows the transmission spectrum of the variable wavelength filter 15 injected with carriers from the electrodes, 25 and 27. The solid line in FIG. 2 corresponds to the transmission spectrum of the first ring resonator 21, while, the dotted line shows that of the second ring resonator 23.

Because the ring waveguides, 29 and 31, each has the specific optical path length different from the other, which means that the FSR is different from the other, the variable wavelength filter 15 transmits substantially no light when the ring waveguides, 29 and 31, are injected no currents from the electrodes, 25 and 27. When an electrical signal is applied to the electrodes, 25 and 27, which changes the refractive index of the ring waveguides, 29 and 31, the transmission maxima and the FSR thereof varies. Therefore, as shown in FIG. 2, one of the transmission maxima of the ring resonator 21 can be tuned with one of the transmission maxima of the other ring resonator 23 by adjusting the injected current. In such a case, the light with the wavelength λr may transmit the ring resonator 21 also the other ring resonator 23, which means that the variable wavelength filter 15 shows a maximum transmittance at the specific wavelength λr. This specific wavelength λr may be varied by the injected current applied to the electrodes 25 and 27; accordingly, the filter 15 may show the variable wavelength function.

Moreover, the variable wavelength filter 15 may change the specific wavelength λr by applying a relatively smaller current, because the variable wavelength filter 15 uses, what is called, the vernier effect by two ring resonators. In the present embodiment, although the current is injected to change the FSR, the variable wavelength filter 15 may be applied an inverse voltage signal for the pn junction to the electrode thereof.

Next, a configuration of the device 11A will be described as referring back to FIG. 1. The light-emitting device 11A provides two semiconductor waveguides, 39 and 41, each optically coupled with the variable wavelength filter 15 and extending substantially in perpendicular to the facet 47 of the substrate.

A portion of the waveguide 39 close to the end portion 39a is coupled with the ring waveguide 29. The coupling portion between the ring waveguide 29 and the semiconductor waveguide 39 may be different from the coupling portion between the ring waveguide 29 and the other semiconductor waveguide 33. The optical coupling between the waveguide 39 and the ring waveguide 29 may be performed by an optical coupler, for instance, the optical directional coupler or the MMI coupler. The other portion 39b of the waveguide 39 is optically coupled with the active waveguide 17 in the light-generating portion 13a. Thus, the variable wavelength filter 15 may be coupled with the light-generating portion 13a. The ring waveguide 31 is coupled with a portion of the waveguide 41 close to the end portion 41a by an optical coupler with types of, for instance, the optical directional coupler or the MMI coupler.

As illustrated in FIG. 1, the waveguides, 39 and 41, may also be terminated in the end portions thereof, 39a and 41a, to reduce the reflection at the end similar to the end portions, 33a and 33b, of the waveguide 33. In a modification of the present embodiment, the semiconductor waveguides, 39 and 41, may be built with the variable wavelength filter 15.

The facet 47 is covered by a film R1 to show low reflectivity, for instance, from 0.001 to 1% in a wavelength region where the variable wavelength filter 15 may vary its specific wavelength λr. The film R1 also covers the end 41b of the waveguide 41. The other facet 49 of the substrate, that is, the end facet close to the light-generating portion 13a is unconcerned with its reflectivity in the present embodiment. The facet 49 may be coated with a film to show high reflectivity, or to show low reflectivity.

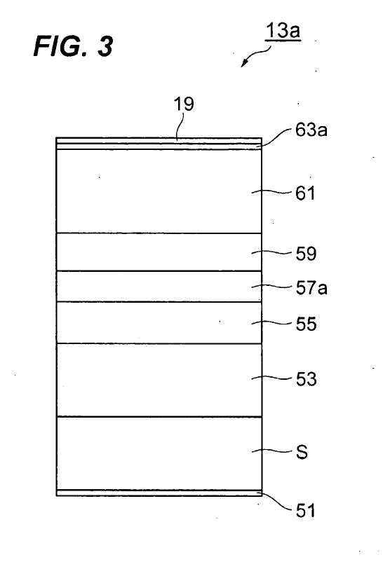

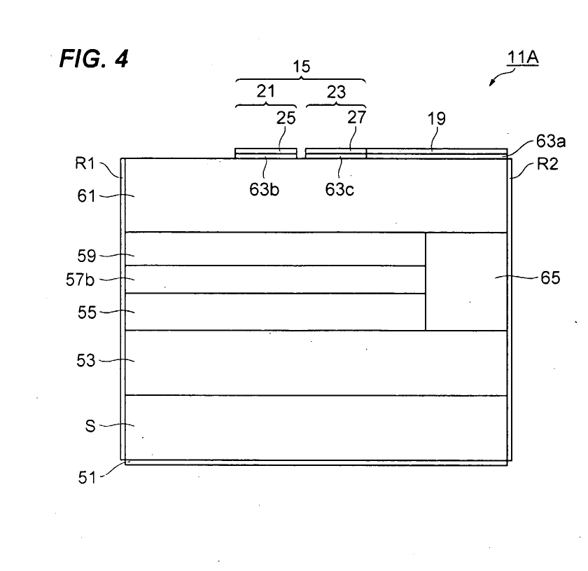

FIG. 3 is a cross section of the device 11A taken along the line III-III shown in FIG. 1, which corresponds to the cross section of the light-generating portion 13a, while, FIG. 4 is another cross section of the device 11A taken along the line IV-IV shown in FIG. 1.

As shown in FIGS. 3 and 4, the device 11A provides a substrate S on which the light-generating portion 13a, the variable wavelength filter 15, and so on, are formed. The back surface of the substrate S is wholly covered with the electrode 51. The light-generating portion 13a includes, when the substrate has the n-type conduction, an n-type cladding layer 53, an optical guiding layer 55, an active layer 57a that includes the quantum well structure, another optical guiding layer 59, a p-type cladding layer 61, and a contact layer 63a in this order on the substrates. On the contact layer 63a is formed with the upper electrode 19.

The ring resonators, 21 and 23, also includes the n-type cladding layer 53, the optical guiding layer 55, a waveguide core 57b, the upper optical guiding layer 59 and the p-type cladding layer 61. Further, two contact layers, 63b and 63c, cover portions of the p-type cladding layer 61, and on the contact layer, 63b and 63c, are formed with the electrodes, 25 and 27. Three contact layers, 63a to 63c, are isolated to each other. The optical confinement along the layer stacking is performed by two cladding layers, 53 and 61, accompanied with respective guiding layers, 55 and 59, while, the confinement along the layers is performed by the striped structure of the active waveguide that includes two optical guiding layers, 55 and 59, and the active layer 57a, and is buried with the burying layer 65 as shown in FIG. 4.

For the ring resonators, 21 and 23, the striped structure including two optical guiding layers, 53 and 59, and the waveguide core 57b, may be formed in respective ring waveguides, 29 and 31, by the photolithography and subsequent semiconductor processes, and buries this striped structure by the burying layer 65. The waveguides, 33, 39 and 41, have the same structure with the ring resonators, 21 and 23, except for their plane shape and accompanied with no contact layers and electrodes.

The active layer 57a in the light-generating portion 13a may have the quantum well structure made of quaternary compound semiconductor material of GaInAsP/GaInAsP with different compositions for the well layers and the barrier layers, respectively. This quantum well structure shows an optical gain in a wavelength region from 1.25 to 1.65 μm. The waveguide core 57b may be a GaInAsP with a band gap wavelength less than that of the well layers in the active layer 57a, which is equivalent to a condition that the band gap energy of the waveguide core 57b is greater than that of the well layers. Two cladding layers, 53 and 61, with the n-type and p-type conduction, respectively, may be InP, while, the contact layers, 63a to 63c, may be heavily doped GaInAs. When the substrate S has the p-type conduction, the lower cladding layer 53 is the p-type conduction, while, the upper cladding layer 61 may be the n-type conduction. The film R1 with low reflectivity is formed on the facet 47.

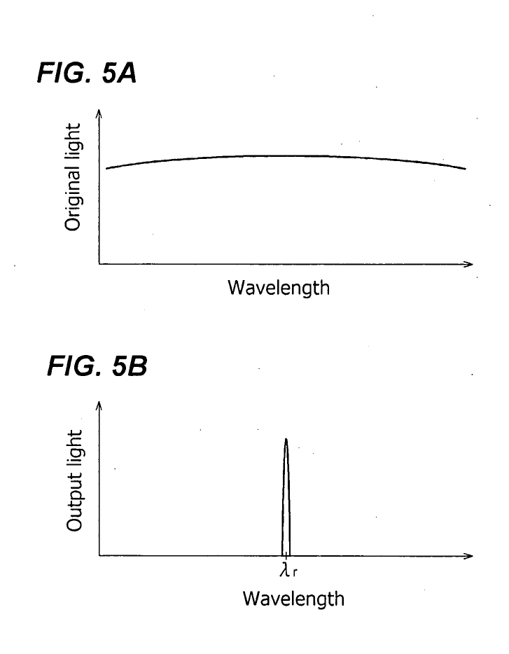

An operation of the device 11A will be described as referring to FIGS. 2, 5A and 5B. FIG. 5A schematically illustrates an output spectrum of the light-generating portion 13a, while, FIG. 5B schematically illustrates an output spectrum of the device 1A. The explanation provided below concentrates on a case where two ring resonators, 29 and 31, are injected with the current from the electrodes, 25 and 27, to tune the specific wavelength λr common to two ring waveguides, 29 and 31.

First, the current is injected into the active layer 57a from the electrode 19 to cause the super luminescent light with a broad spectrum in the light-generating portion 13a as shown in FIG. 5A. The light-generating portion 13a optically couples with the variable wavelength filter 15, so, the light from the light-generating portion 13a first enters the wavelength variable filter 15. Because the wavelength variable filter 15 has the specific wavelength λr, the wavelength variable filter 15 may selectively transmit the light with the wavelength λr from the super luminescent light from the light-generating portion 13a. The light output from the wavelength variable filter 15 propagates in the waveguide 41 and is output from the facet 47. Thus, the light emitted from the facet 47 has the sharp spectrum, a center of which coincides with the specific wavelength λr of the variable wavelength filter 15.

The light output from the light-generating portion 13a shows the broad spectrum, from which the light with the sharp spectrum at the specific wavelength λr is selected by the variable wavelength filter 15. The output light from the device 11A is, although it shows the sharp spectrum, independent of the mode hopping inherently attributed with the laser oscillation. Moreover, the device 11A is unnecessary to provide a mechanism to generate the coherent light, in other words, the optical resonator for the laser emission to adjust the phase of the light. Still further, the wavelength variable filter 15 may easily adjust the specific wavelength λr by injecting carries into the ring waveguides, 29 and 31, from the electrodes, 25 and 27, which means that the selection of the specific wavelength may be also easily carried out.

Moreover, because the device 11A is free from the mode hopping, the output power of the light may be stabilized. In addition, the original light output from the light-generating portion 13a is the super luminescent light and has the broad spectrum, and the variable wavelength filter 15 performs the vernier effect; accordingly, the wavelength of the light output from the device 11A may be widely varied with less injected current. The film R1 on the facet 47 with the low reflectivity makes it impossible to form the optical resonator between two facets, 47 and 49, which may suppress the laser oscillation and the mode hopping.

### Second Embodiment

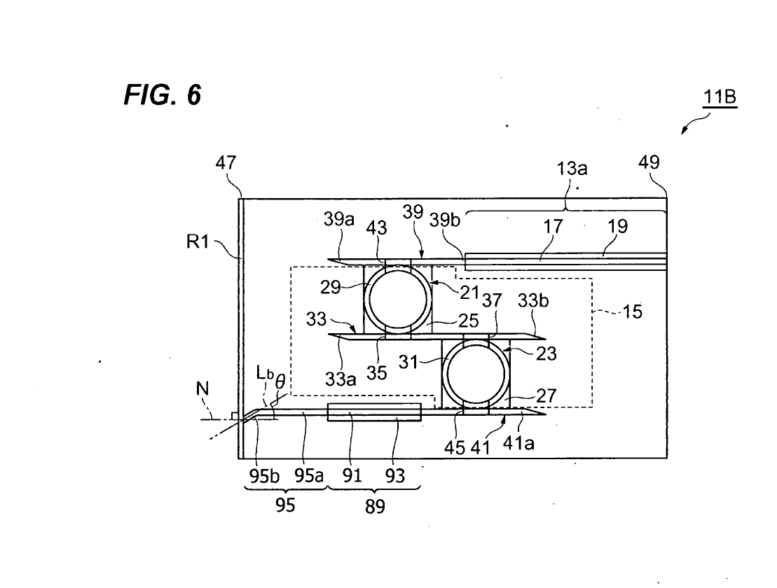

FIG. 6 is a plane view schematically showing a light-emitting device 11B according to the second embodiment of the present invention. The device 11B shown in FIG. 6 has the same configuration with those of the first embodiment except that the present device 11B provides a semiconductor optical amplifier (hereafter denoted as SOA) 89 built on the substrate S and provides a the third semiconductor waveguide 95 between the SOA 89 and the facet 47.

The SOA 89 is arranged between the variable wavelength filter 15 and the facet 47, in other word, it is formed in an extended portion of the semiconductor waveguide 41. The SOA 89, optically coupled with the variable wavelength filter 15 through the waveguide 41, amplifies the light output from the filter 15. The arrangement of the SOA 89 may be similar to those known in the fields, for instance, the SOA 89 may provide an active waveguide 91 including an active layer and an electrode 93 on the active waveguide 91 to inject carriers into the waveguide 91.

The arrangement of the device 11B may output the light output from the filter 15 and amplified by the SOA 89, which may compensate the optical loss in the variable wavelength filter 15, or the optical absorption inherently attributed with the semiconductor materials and may obtain the light with relative high power. In one modification of the present embodiment, the device 11B may provide, instead of the SOA 89 or in addition to the SOA 89, an optical modulator between the filter 15 and the facet 47 when the device 11B is un-modulated in the light-generating portion 13a directly. The optical modulator may be a type of the electro-absorption modulator or the Mach-Zender modulator.

The device 11B may further provide another semiconductor waveguide 95 between the SOA 89 and the facet 47. This waveguide 95, guiding the light amplified by the SOA 89 to the facet 47, bends its optical axis in a side close to the facet 47, that is, the waveguide 95 includes a straight portion 95a extending in parallel to the waveguide 41 and a bent portion 95b close to the facet 47. The bent portion 95b may be bent in the axis Lb thereof by 3 to 12° with respect to the normal N of the facet 47. The layer arrangement of the waveguide 95 may be the same with those of the other waveguides, 33, 39 and 41.

The light amplified by the SOA 89 is output from the facet 47 after propagating in the waveguide 95. Because of the bent arrangement of the waveguide 95, the light propagating in the waveguide 95 enters the facet 47 by an oblique angle determined by the bent angle, which suppresses the light reflected at the facet 47 and back to the SOA 89. Accordingly, the device 11B effectively reduces not only the mode hopping but the optical noise caused by the stray light entering the SOA 89.

### Third Embodiment

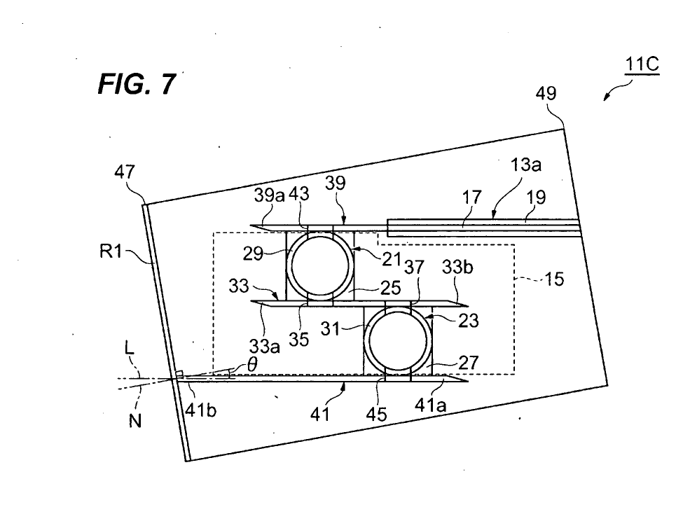

FIG. 7 is a plane view schematically showing a light-emitting device 11C according to the third embodiment of the invention. The device 11C has the same arrangement with the device 11A already described except that, in the present device 11C, the waveguide 41 makes a substantial angle e with respect to the normal N of the facet 47. The angle E between the axis L of the waveguide 41 and the facet 47 may be 3 to 12°, which is comparable to the bent angle of the waveguide 85 of the previous device 11B. The device 11C may be obtained such that the light-generating portion 13a and the variable wavelength filter 15 are firstly formed on the substrate S as already explained in the first embodiment and the substrate S is cut or cleaved such that the axis L of the waveguide 41 makes the angle θ with respect to the facet 47.

In the device 11C, the light propagating in the waveguide 41 enters the facet 47 with the substantial angle as already explained, which effectively controls so as not to form the optical resonator between two facets, 47 and 49. Accordingly, the optical output power from the device 11C may be further stabilized because of the prevention of the mode hopping.

### Fourth Embodiment

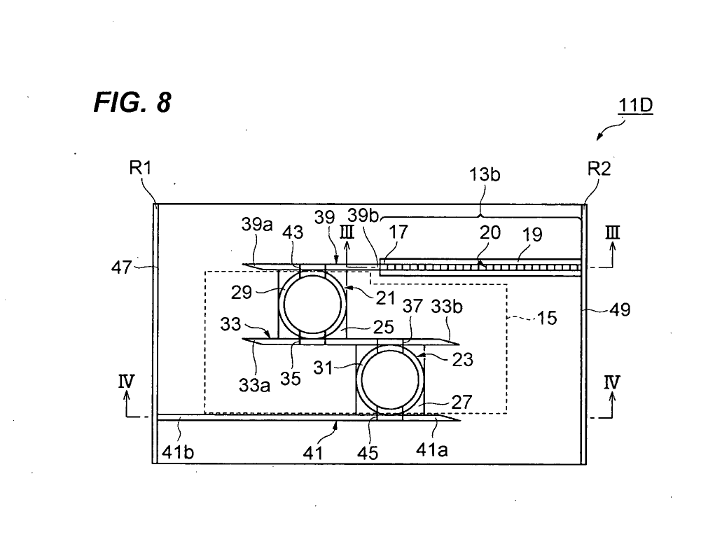

Next, another light-emitting device 11D according to the fourth embodiment of the invention will be described. FIG. 8 is a schematic plane view of the light-emitting device 11D. This device 11D provides the same arrangement with those of the foregoing device 11A of the first embodiment except that the present device 11D provides a modified light-generating portion 13b. The light-generating portion 13b includes the semiconductor waveguide 17, within which the diffraction grating 20 whose Bragg diffraction wavelength is λB is formed, and the electrode 19 to inject carriers into the waveguide 17. The light-generating portion 13b is a type of the distributed feedback (DFB) laser diode that causes a laser emission whose wavelength is determined by the diffraction grating 20. Thus, the emission wavelength of the light-generating portion 13b becomes the Bragg diffraction wavelength λB.

When one of the transmission maxima of the first ring resonator 21 coincides with one of the transmission maxima of the second ring resonator 23, which causes the variable wavelength filter 15 shows the specific wavelength λr, and when this specific wavelength λr coincides with the diffraction wavelength λB, the light generated in the light-generating portion 13b may transmit through the variable wavelength filter 15. The specific wavelength λr may be varied, as already explained in the first embodiment, by injecting the carriers therein; accordingly, the light with the diffraction wavelength λB from the light-generating portion 13b may transmit through the filter 15 by tuning the specific wavelength λr to the diffraction wavelength λB.

The spectral width of the pass band of the filter 15 is able to be far narrower than that of the light generated in the light-generating portion 13b. Because the light-generating portion 13b includes the diffraction grating 20, the spectral width of the light output form the generating portion 13b is inherently narrow enough. However, when the generating portion 13b is directly modulated, the spectral width thereof is widened due to the chirp. The present embodiment may make the light output from the generating portion 13b monochromatic enough by transmit it through the variable wavelength filter 15.

Providing the wavelength range where the variable wavelength filter 15 may tune its specific wavelength λr is from λs to λl (λs<λl), the filter 15 may be independent of the configuration thereof, such as the optical path length of the ring resonators, 29 and 31, the number of the electrodes, 25 and 27, and the number of the ring waveguides, 29 and 31, as long as the range (λs˜λl) of the specific wavelength λr overlaps the diffraction wavelength λB.

Specifically, the variable wavelength filter 15 shown in FIG. 8 provides two ring waveguides, 29 and 31, with respective electrodes, 25 and 27, while, only one of the ring waveguides, 29 or 31, may provide the electrode. The explanation below concentrates on a condition where the first ring waveguide 29 excludes its electrode 25. In this case, the optical path length of the ring waveguide 29 is necessary to be set such that one of the transmission maxima coincides with the diffraction wavelength λB. On the other hand, the optical path length of the other ring waveguide 31 is set such that, by the current injection to the waveguide, one of the transmission maxima may coincide with the diffraction wavelength λB. Thus, the arrangement described above may selectively transmit the light with the diffraction wavelength λB by adjusting the transmission maxima of the ring resonator 23.

The other facet 49 of the generating portion 13b opposite to the waveguide 39 may provide a film R2 to show substantial reflectivity, for instance, a high-reflectivity (HR) coating showing the reflectivity from 80 to 95%. Such an HR film may enhance the optical power obtainable from the device 11D. When the generating portion 13b provides the diffraction grating with the λ/4 shift function, the facet 49 covered with the film R2 preferably shows low reflectivity or unti-reflectivity less than 1% to enhance the stability of the emission wavelength and the monochromatic characteristic.

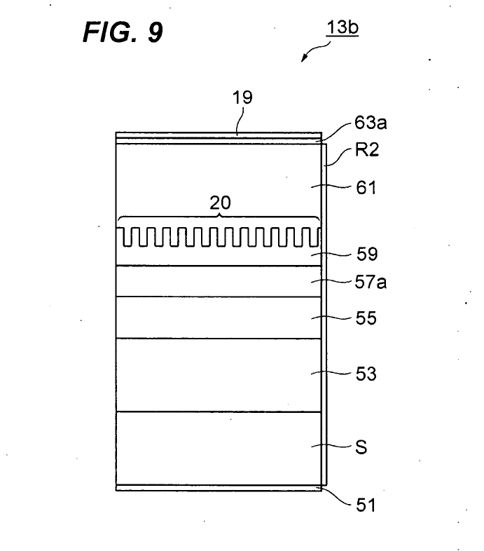

Next, the light-generating portion 13b of the present embodiment will be described as referring to FIG. 9. The generating portion 13b has substantially same structure with those of the generating portion 13a except that the interface between the upper guiding layer 59 and the upper cladding layer 61 shows a periodic corrugation that causes the function of the diffraction grating due to the difference in the refractive indices between the layers, 59 and 61.

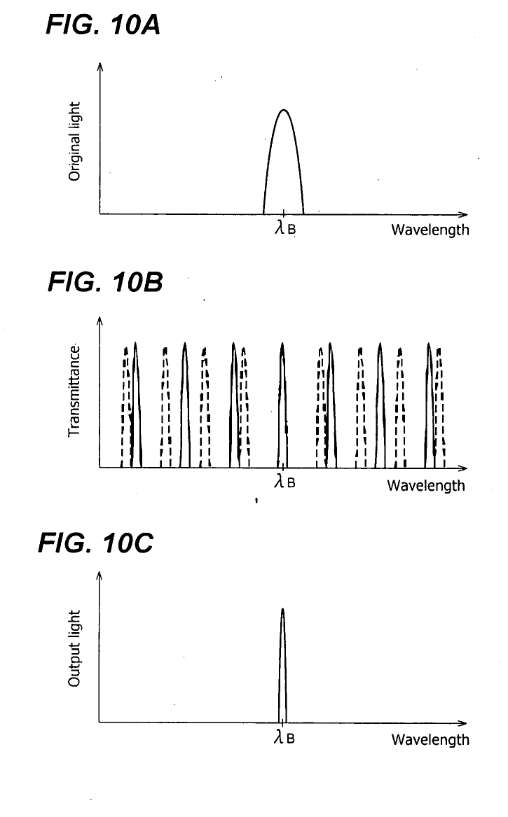

Because the generating portion 13b provides this diffraction grating 20, the light output therefrom inherently shows a monochromatic characteristic with substantially single wavelength. However, the practical light output from the generating portion 13b has a spectral width, the center of which corresponds to the diffraction wavelength λB. Especially, when the generating portion 13b is directly modulated that causes the fluctuation of the carrier density in the active layer 57a and also varies the refractive index thereof, the spectral width of the light output from the generating portion 13b is broadened. FIG. 10A schematically illustrates such a spectrum with a broadened spectral width around the diffraction wavelength λB.

The wavelength variable filter 15 may tune the specific wavelength λr thereof by injecting the current into the ring waveguides, 29 and 31, as illustrated in FIG. 10B. Under this condition, that is, the specific wavelength λr coincides with the diffraction wavelength λB, entering the light output from the generating portion 13b into the filter 15; the light with the diffraction wavelength λB may selectively transmits the filter 15. Accordingly, as shown in FIG. 10C, the device 11D may output the light with the spectral width narrower than the original light output from the generating portion 13b.

Moreover, even when the generating portion 13b directly modulates its optical output, the device 11D may output the light with the spectral width narrower than the original width because the variable wavelength filter 15 is independent of the modulation and has the transmission spectrum narrower than the spectral width of the original light output from the generating portion 13b. Further, the variable wavelength filter 15 provides two ring resonators, 21 and 23, coupled in series to each other, which means that the original light from the generating portion 13b transmits two band-pass filters, 21 and 23. Thus, the light output from the variable wavelength filter 15 may be further narrowed in the spectral width thereof.

### Fifth Embodiment

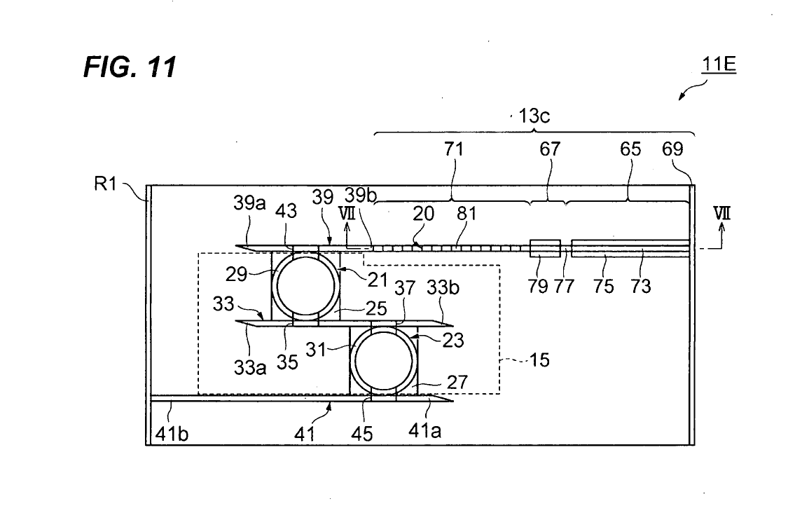

FIG. 11 schematically illustrates the light-emitting device according to the sixth embodiment of the invention. The device 11E provides, instead of the generating portion 13b types of the DFB laser diode in the foregoing embodiment, a light-generating portion 13c with a type of the DBR laser diode. Next, differences between the fifth embodiment and the sixth embodiment will be described.

The light-generating portion 13c comprises a gain waveguide 65, a phase adjustor 67 and two optical reflectors, 69 and 71, which defines the laser cavity for the DBR laser diode. The gain waveguide 65 and the phase adjustor 67 are arranged in series within the laser cavity.

The gain waveguide 65 includes the waveguide 73 and the electrode 75 accompanied with the waveguide 73. The waveguide 73 shows an optical gain by the carrier injection from the electrode 75. The phase adjustor 67 includes a semiconductor waveguide 77 optically coupled with the waveguide 73 and the electrode 79 accompanied with the waveguide 77. The phase adjuster 67 shows the function to adjust the phase of the light propagating in the waveguide 77 by applying an electrical signal to the electrode 79. The electrical signal may be a current signal or a voltage signal.

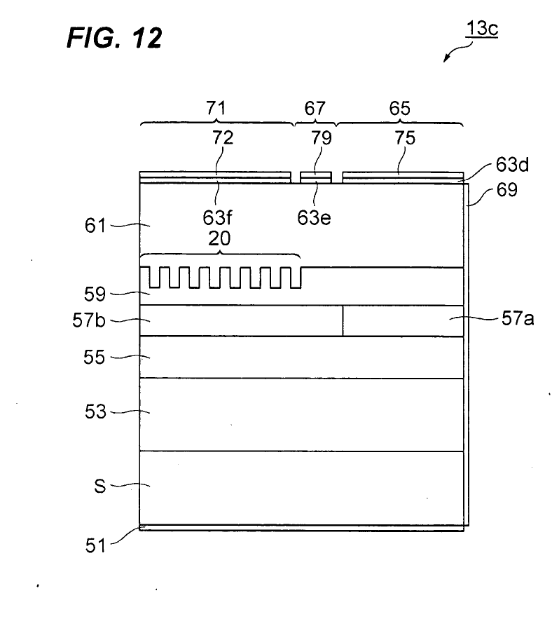

The reflector 69, formed in the end of the gain waveguide 73, may be a reflection film with high reflectivity, namely, the HR coating. While, the other reflector 71 includes a semiconductor waveguide 81 that is optically coupled with the waveguide 77 in the phase adjustor 67. This waveguide 81 provides, in a specific layer, a grating with the diffraction wavelength λB. The reflector 71 may accompany with the electrode 72, which is shown in FIG. 12, to adjust the diffraction wavelength λB.

Next, the structure of the light-generating portion 13c of the present embodiment will be described as referring to FIG. 12, which is a cross section taken along the line VII-VII illustrated in FIG. 11.

The gain waveguide 65 provides, on the n-type semiconductor substrate S, the n-type cladding layer 53, the optical guiding layer 55, the active layer 57a including the quantum well structure, the upper optical guiding layer 59, the upper p-type cladding layer 61 and the contact layer 63d. On the contact layer 63d is formed with the electrode 75. The phase adjustor 67 has the same structure with the gain waveguide 65 except that the active layer 57a is replaced with the core waveguide 57b. The reflector 71 has the same structure with the phase adjustor 67 except that the interface between the upper optical guiding layer 59 and the upper p-type cladding layer 61 has a periodic corrugation that shows, the function of the diffraction grating. As already explained, the reflector 71 may accompany with the electrode 72. The contact layers, 63d to 63f, are physically isolated to each other.

The optical confinement in the generating portion 13c is the same with those performed by the generating portions, 13a and 13b.

In the generating portion 13c, the light caused in the active layer 57a of the gain waveguide 65 by the carrier injection from the electrode 75 and having the wavelength coinciding with the diffraction wavelength λB may run within the laser cavity between the reflectors, 69 and 71. The phase adjustment during the single round of the light may be carried out by the phase adjuster 67. Once the laser oscillation occurring, that is, the phases of the light running between two reflectors, 69 and 71, becomes coherent, the generating portion 13c outputs the coherent light with the diffraction wavelength λB.

The arrangement of the device 11E is the same with those of the previous device 11D except for the light-generating portion 13c instead of the generating portion 13b. Accordingly, the operation and the function of the device 11E become substantially same with that of the foregoing device 11D.

### Sixth Embodiment

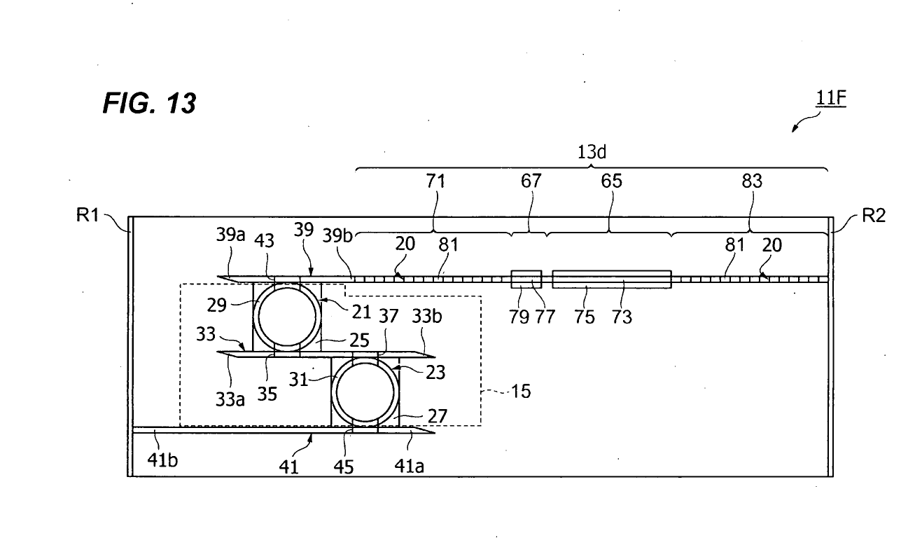

The embodiment shown in FIG. 11 provides the reflective film 69 as one of the reflector of the laser cavity; however, the reflective film 69 may be replaced by the distributed Bragg reflector 83 with the same structure with that of the counter reflector 71, as shown in FIG. 13. Moreover, these reflectors, 71 and 83, with the DBR structure may have an inhomogeneous diffraction grating such as the sampled grating and the super-structure grating.

The DBR reflector 83, which is coupled with the gain waveguide 65, also comprises the semiconductor waveguide 81 that includes the diffraction grating 20. The arrangement of the light-emitting device 11F is the same with those of the foregoing device 11E; accordingly, the device 11F may bring the same function and the result with those of the previous devices 11E. Moreover, the device 11F may further provide the film R2 in the facet thereof. This film R2, similar to the film R1 accompanied with the previous device 11D, may be either a high reflection film or an unti-reflection film.

### Seventh Embodiment

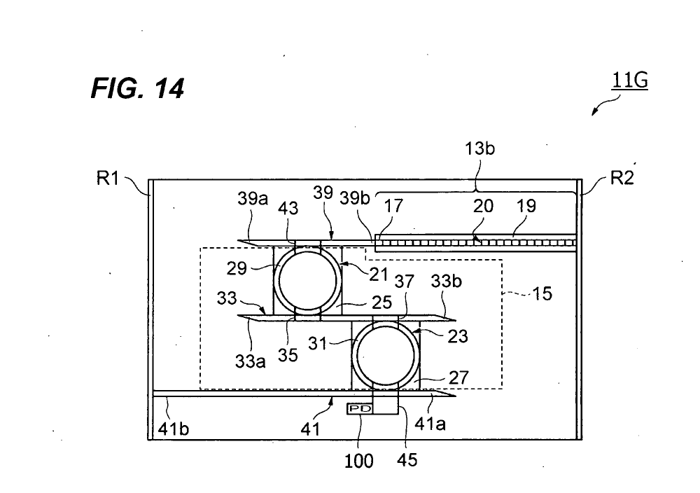

FIG. 14 schematically illustrates a light-emitting device 11G according to the seventh embodiment of the invention. The configuration of the device 11G is the same with those of the previous device 11D except that the present device 11G further provides a PD 100; accordingly, the device 11G shows the same function and the result with those of previous devices, 11A to 11F.

The PD 100, which is formed on the substrate S, optically couples with the ring waveguide 31 through the optical coupler 45. The optical coupler 45 not only optically couples the ring waveguide 31 with the semiconductor waveguide 33 but splits the light output from the ring waveguide 31 to guide the split light into the PD 100. The PD 100 may have a conventional structure built on the substrate S, for instance, the PD integrates an active layer that generates photocurrent by the incident light and electrodes to extract the photocurrent. Thus, the PD 100 detects the amplitude of the light transmitted through the variable wavelength filter 15.

The light-emitting device 11G may adjust the injection current applied to the ring waveguides, 29 and 31, based on the output from the PD. For instance, the device 11G may set the injection current to the variable wavelength filter 15 so as to become the output of the PD 100 maximum. As the specific wavelength λr of the filter 15 is tuned to the diffraction wavelength λB of the generating portion 13b, the output of the PD 100 increases. Therefore, by adjusting the current injection to the filter 15 depending on the output of the PD 100, the specific wavelength λr becomes close to the diffraction wavelength λB, namely, a difference between the specific wavelength λr and the diffraction wavelength λB becomes smaller, and the optical output from the device 11G may be tuned in the wavelength thereof to the diffraction wavelength λB and may be enhanced in the magnitude thereof.

The device 11G provides the light-generating portion 13b with the DFB structure. However, the device 11G may provide other types of the generating portions, such as the LED structure 13a and the DBR structures, 13c and 13d. In other words, the light-emitting devices, 11A to 11F, may provide the PD 100.

### Eighth Embodiment

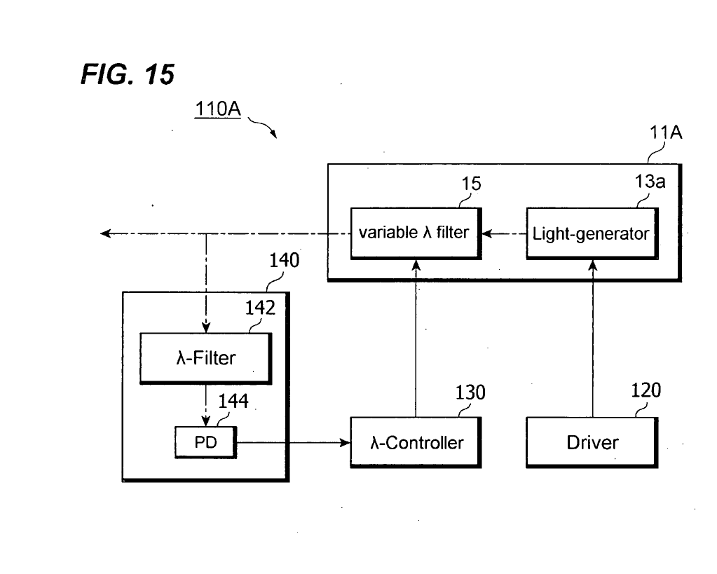

Next, an optical signal source providing the light-emitting device 11A described above will be explained. FIG. 15 schematically illustrates a block diagram of the signal source 110A according to the eighth embodiment.

The optical signal source 110A includes the light-emitting device 11A, a driver 120 electrically connected with the light-generating portion 13a in the device 11A, a wavelength controller 130 electrically connected with the variable wavelength filter 15, and a wavelength monitor 140 connected with the wavelength controller 130. The device 11A has the same configuration with those described as the first embodiment.

The driver 120 provides a driving signal to the light-generating portion 13a to generate the super luminescent light. The wavelength controller 130 provides the injection current to the variable wavelength filter 15, through the electrodes, 25 and 27, to tune the specific wavelength λr of two ring waveguides, 29 and 31. The wavelength-controller 130 adjusts this injection current based on the signal output from the wavelength monitor 140. Thus, these members, the device 11A, the controller 130 and the wavelength monitor 140, constitute a feedback controlling loop for the output wavelength.

The wavelength monitor 140 includes a wavelength filter 142 that transmits light with preset wavelengths and a PD 144 to detect the transmitted light through the filter 142. The filter 142 may be a type of the etalon filter where the transmittance thereof is dynamically adjustable.

The filter 142 is arranged such that it may receive a portion of light output from the facet 47 of the device 11A. For instance, it may be applicable that a beam splitter is placed on the optical path from the device 11A and the filter 142 is arranged so as to detect a portion of light split by the beam splitter. The PD 144, detecting the filtered light, sends a photocurrent depending on the magnitude of the filtered light to the wavelength controller 130. Here, the information to be transmitted to the controller 130 from the PD 144 includes those when the PD 144 receives no light.

The filter 142 in the wavelength monitor 140 only transmits the light with wavelengths around the preset one, that is, the filter 142 is a type of the band pass filter; accordingly, the PD 144 may generate the photocurrent only when the light coming in the filter 142 contains wavelengths passed by the filter 142. When the wavelength of the ling coming in the filter 142 is shifted from the pass band of the filter 142, the PD generates substantially no signal. When the wavelength controller 130 receives the information from the PD 144 that the wavelength of the output light mismatches with the pass band of the filter 142, the controller 130 adjusts the current applied to the electrodes, 25 and 27, such that the PD 144 detects the filtered light. Thus, the signal source 110 may securely output the light with the wavelength determined by the wavelength filter 142.

Because the signal source 110A provides the feedback loop to select the wavelength of the output light, the signal source 110A may stabilize the wavelength of the output light. In addition, because the device 11A has the configuration same with those described in the first embodiment, the signal source 110A may stabilize the output power thereof because the device 11A, as already described, shows substantially no mode hopping.

In the embodiment above described, the signal source 110A carries out the feedback control to stabilize the output wavelength. However, in a case where the optical signal only requests a roughly controlled wavelength, the signal source 110 may omit the wavelength monitor 140 and may only carry out the open loop control by the device 11A and the wavelength controller 130.

### Ninth Embodiment

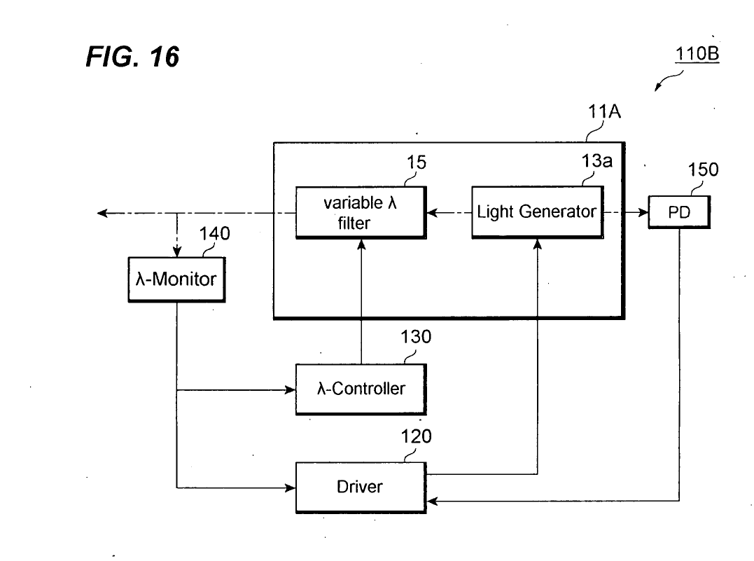

FIG. 16 schematically illustrates a block diagram of another optical source 110B. The configuration of this optical signal source 110B is substantially same with those previously shown in FIG. 15 except that the present signal source provides another PD 150 to detect a back facet light emitted from the facet 49 of the light-emitting device 11A. This PD 150 may be built with the light-emitting device 11A on the substrate S. The PD 150 is electrically connected with the driver 120 and outputs the photocurrent thereto. The driver 120 may control the current provided to the light-generating portion 13a, which adjusts the optical power output from the generating portion 13a.

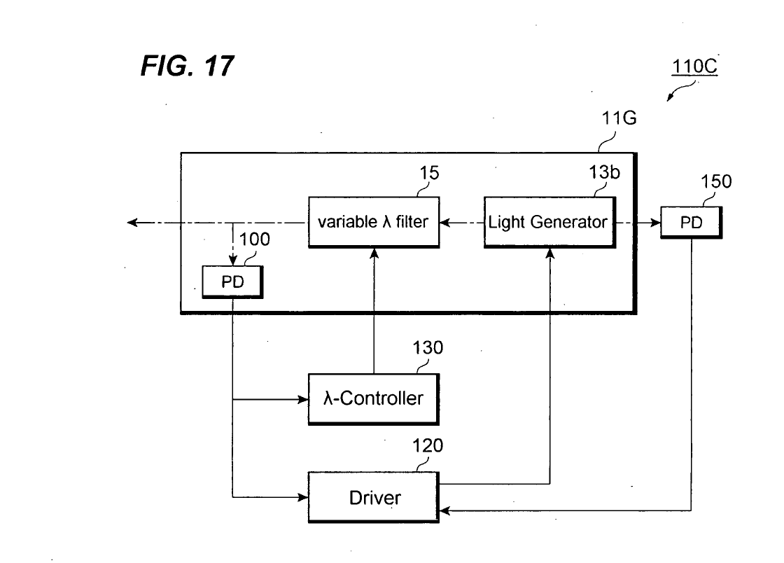

When the light-emitting device integrates the PD 100, the optical signal source 110C, as illustrated in FIG. 17, two PDs are utilized to control the output power and the output wavelength of the signal source 110C. That is, the PD 100 built within the light-emitting device precisely detects and adjusts, co-operating with the wavelength controller 130, the output wavelength of the device 11G such that the wavelength controller supplies the injection current to the filter 15 so as to maximize the output power of the PD 100. On the other hand, the back facet PD 150 detects the original optical power output from the light-generating portion 13b. Thus, the optical signal source 110C illustrated in FIG. 17 may precisely control the output power and the output wavelength thereof.

Although the optical signal sources, 110A to 110C, described above have the light-emitting device, 11A or 11G, according to the first embodiment or the seventh embodiment, respectively, the signal sources, 110A to 110C, may provide the other light-emitting devices, 11B to 11F, without any modifications of the driver 120, the wavelength controller 130 and the wavelength monitor 140 to show the same function and the same result with that of the optical signal source 110A.

While the preferred embodiments of the present invention have been described in detail above, many changes to these embodiments may be made without departing from the true scope and teachings of the present invention. For example, the variable wavelength filter 15 may comprise three or more ring waveguides. Further, all ring waveguides in the filter 15 are unnecessary to provide corresponding electrodes. Especially, when the light-generating portion is a type of the LED, 13a, only one of ring waveguides provides the electrode to tune the transmission maxima thereof so as to coincide with one of transmission maxima of the other ring waveguide. In this case, the specific wavelength λr coincides with one of the transmission maxima of the other ring waveguide. Similarly, when the filter 15 comprises three or more ring waveguides, two of them may provide the electrodes.

On the other hand, when the light-generating portion has the type of the DFB shown in the device 11b, or the type of the DBR shown in the device 11c, the variable wavelength filter 15 may provide only one ring waveguide with the control electrode. In this case, the one of the transmission maxima of the ring waveguide may be tuned, by the current injection, to the Bragg diffraction wavelength λB. Because the spectral width of each transmission maxima of the ring resonator is far smaller than that of the light output from the generating portion, 13b or 13c, the spectral width of the light output from the device may be extremely narrowed.

The light-emitting devices, 11A and 11C to 11F may provide, instead of the semiconductor waveguide 41, the waveguide 95 whose axis bends by the preset angle with respect to the facet 47. In this case, one side of the waveguide 95 is necessary to couple with the variable wavelength filter 15. On the other hand, the device 11B that provides the SOA 89 is unnecessary to have the distinctive waveguide 95, while, the devices, 11C to 11G, may have the SOA 89.

Moreover, the SOA 89 is arranged between the filter 15 and the output facet 47; however, the devices, 11A to 11G, may arrange the SOA 89 in a position where the SOA is able to amplify the light output from the light-generating portion, 13a to 13d. The devices, 11A to 11G, may arrange the SOA 89 between the ring waveguides in the filter 15.

What is claimed is:

1. A light-emitting device with a variable output wavelength, comprising:
a light-generating portion for generating light by injecting carriers therein; and
a variable wavelength optically coupled with said light-generating portion to transmit said light, said variable wavelength filter including a first ring waveguide with an electrode, said ring waveguide showing a plurality of transmission maxima, one of said transmission maxima being tuned to a wavelength of said light generating in said light-generating portion by applying an electrical signal to said electrode.

2. The light-emitting device according to claim 1,
wherein said variable wavelength filter further includes a second ring waveguide with an electrode, said second ring waveguide showing a plurality of transmission maxima, one of said transmission maxima of said first ring waveguide being aligned with to one of said transmission maxima of said second ring waveguide to show a specific wavelength of said variable wavelength filter by applying a second electrical signal to said electrode of said second ring waveguide,
wherein said specific wavelength is tuned to said wavelength of said light generated in said light-generating portion.

3. The light-emitting device according to claim 2,
wherein said light-generating portion is a light emitting diode to emit super luminescent light with a wide spectrum.

4. The light-emitting device according to claim 2,
further comprising a substrate to form said light-generating portion and said variable wavelength filter thereon, said substrate including a facet with a coating film showing low reflectivity to output light transmitted through said variable wavelength filter.

5. The light-emitting device according to claim 4,
wherein said substrate further includes a semiconductor optical amplifier to amplify said light transmitted through said variable wavelength filter and to output light amplified by said semiconductor optical amplifier from said facet.

6. The light-emitting device according to claim 4,
wherein said substrate further includes a semiconductor waveguide with an optical axis between said variable wavelength filter and said facet,
wherein said optical axis is inclined with a normal of said facet to reduce a reflection at said facet.

7. The light-emitting device according to claim 2,
further comprising a photodiode to detect light transmitted through said variable wavelength filter,
wherein said first and second electrical signals applied to said first and second electrodes, respectively, are determined based on said light detected by said photodiode.

8. The light-emitting device according to claim 7,
further comprising a filter to transmit light transmitted through said wavelength variable filter to said photodiode.

9. The light-emitting device according to claim 7,
further comprising a substrate to form said light-generating portion, said wavelength variable filter and said photodiode thereon.

10. The light-emitting device according to claim 1,
wherein said light-generating portion includes a DFB laser diode to generate said light with an emission wavelength,
wherein one of said transmission maxima of said ring waveguide of said variable wavelength filter is tuned to said emission wavelength.

11. The light-emitting device according to claim 10,
further comprising a substrate to form said light-generating portion and said variable wavelength filter, said substrate including a facet to output light transmitted through said variable wavelength filter and another facet to reflect light generated in said light-generating portion.

12. The light-emitting device according to claim 11,
wherein said substrate further includes a photodiode to detect a portion of light transmitted through said wavelength variable filter,
wherein said first electrical signal applied to said first electrode of said first ring waveguide is determined based on said light detected by said photodiode.

13. The light-emitting device according to claim 11,
wherein said substrate further includes a semiconductor optical amplifier arranged between said wavelength variable filter and said facet to amplify said light transmitted through said wavelength variable filter.

14. The light-emitting device according to claim 1,
wherein said light-generating portion includes a DBR laser diode to generate said light with an emission wavelength,
wherein one of said transmission maxima of said ring waveguide of said variable wavelength filter is tuned to said emission wavelength.

15. The light-emitting device according to claim 14,
further comprising a substrate to form said light-generating portion and said variable wavelength filter thereon, said substrate including a facet with a coating film showing low reflectivity to output light transmitted through said variable wavelength filter and another facet with another coating film showing high reflectivity to reflect light generated in said light-generating portion.

16. The light-emitting device according to claim 14,
wherein said substrate further includes a semiconductor optical amplifier arranged between said wavelength variable filter and said facet to amplify said light transmitted through said wavelength variable filter

17. The light-emitting device according to claim 14,
wherein said DBR laser diode includes an active waveguide to generate said light, a first diffraction grating optically coupled with said active waveguide to reflect said light, a second diffraction grating optically coupled with said active waveguide in a side opposite to said first diffraction grating with respect to said active waveguide to reflect said light, and a phase adjustor arranged between said first diffraction waveguide and said second diffraction waveguide to adjust a phase of said light.
